(19) United States
(12) Patent Application Publication
(10) Pub. No.: US 2011/0285195 A1
(43) Pub. Date: Nov. 24, 2011

(54) SET OF TWIN WHEELS

(75) Inventor: Felix Paludan Ratgen, Vejen (DK)

(73) Assignee: TYRE TRADE DK APS, Vejen (DK)

(21) Appl. No.: 13/147,645

(22) PCT Filed: Feb. 2, 2010
(86) PCT No.: PCT/DK10/50028

§ 371 Date: Aug. 3, 2011

(30) Foreign Application Priority Data
Feb. 3, 2009 (DK) PA 2009 00159

(51) Int. Cl. B60B 11/02

(52) U.S. Cl. 301/36.1

(57) ABSTRACT

The present invention concerns a twin wheel set including twin wheel, intermediate ring and fixing means for coaxial mounting of the twin wheel set on a wheel of a vehicle, where twin wheel as well as vehicle wheel include a rim, preferably a steel rim with tyre. The new feature of the invention consist of the fixing means at least comprising an adjustable clamping ring, preferably a steel ring, for bearing on the rim periphery of the twin wheel at the side facing away from the vehicle wheel, preferably against at least one face on the inner peripheral area of the rim on a twin wheel. By using the outer side of the rim for contact with the adjustable clamping ring, there is achieved an independency of welding means thereon to which clamping devices are to be fixed on the twin wheel itself. By using a clamping ring which is not fixed to the twin wheel, a kind of universal clamping ring can be applied which possibly may be adapted to different sizes of twin wheels, and which therefore implies less need for keeping may different articles in stock at the producer.

### BACKGROUND OF THE INVENTION

1. Field of the Invention

The present invention concerns a twin wheel set, including twin wheel, intermediate ring and fixing means for coaxial mounting of the twin wheel set on a wheel of a vehicle, where the twin wheel as well as the vehicle wheel include a rim, preferably a steel rim with tyre, where the fixing means at least include a clamping ring, preferably a steel ring, for bearing against the rim periphery of the twin wheel at the side facing away from the vehicle wheel, preferably against at least one face of the inner peripheral area of the rim on a twin wheel.

2. Description of Related Art

It is commonly known that in industry and farming, twin mounted wheels are used, i.e. an additional wheel mounted on each of the original wheels of the vehicle in question. The purpose of twin wheels is to distribute the load from the vehicle across a larger area and at the same time achieve a better grip in the base for the drive wheels on the vehicle.

On farms, such twin wheels are often used in certain seasons, and therefore it is advantageous that these twin wheels can be mounted and dismounted according to need. According to the prior art, this is achieved in that between the wheel and the twin wheel there is arranged a kind of clamping device that presses the two wheels against each other. The clamping device is often fixed at one end to the rim of the vehicle and at the other end to an intermediate ring on a twin wheel. In order to ensure that the two wheels are centred precisely in relation to each other, the said intermediate ring is used, typically welded to the rim of the twin wheel. This intermediate ring has a diameter that fits into the rim of the vehicle, and thus an appropriate centering is achieved. The intermediate ring has further the advantage of creating the required distance between two wheels so that the tyre sides are not pressed against each other, or such that the spacing between the two wheels becomes so great that it fits with the row spacing of crops on an agricultural field. The fixing to the vehicle wheels is effected by an anchoring member adapted for the purpose, e.g. an eye bolt or the like, while often there is used an annular collar on the intermediate ring for fixing the other end of the clamping device. A typical clamping device is provided with an adjustable drawbar provided with a closing/clamping mechanism where, as mentioned, there are fixing means at both ends. In most cases, an assembly between a twin wheel and a vehicle wheel include between four and eight clamping devices, but more or fewer may also be applied.

From GB 2 031 351 A is known such a solution where a twin wheel is mounted while applying an intermediate ring and a number of clamping devices which are moved into position along a clamping ring, which is welded on the periphery of the rim.

The fact that the intermediate ring is welded on the rim of the twin wheel creates some inexpediencies. When a tractor or a contractor's machine is to be equipped with twin mounting, it is very often a wish from the customer that these wheels should be delivered with the same colour as that of the original wheels. This causes the delivery time for a set of twin wheels to appear long, as the rims are often first to be painted, or alternatively are first to be welded with the desired intermediate ring, and subsequently be painted in the desired colour. If a dealer of twin wheels wants to shorten the delivery time, he is actually required to have a disproportionately large stock of prefabricated rims of different dimensions and of different sizes of intermediate rings, respectively. By having this large stock, where part of or all rims may be painted in the most current colours, a reasonably short delivery time may be achieved. However, typically it appears that this large stock is not attractive for the supplier as orders for making twin wheels that are not in stock occur anyway. Moreover, it is obviously a drawback with too large stock with rims adapted for specific needs.

### SUMMARY OF THE INVENTION

Therefore, it is the object of the invention to indicate a solution to the above problems where the stock as well as the delivery time can be minimised appreciably compared with the prior art types of twin wheels. Moreover, it is an object to indicate a solution to a twin wheel where the spacing between wheel and twin wheel can be adjusted.

As mentioned in the introduction, the invention concerns a twin wheel set, including twin wheel, intermediate ring and fixing means for coaxial mounting of the twin wheel set on a wheel of a vehicle, where the twin wheel as well as the vehicle wheel include a rim, preferably a steel rim with tyre, where the fixing means at least include a clamping ring, preferably a steel ring, for bearing against the rim periphery of the twin wheel at the side facing away from the vehicle wheel, preferably against at least one face of the inner peripheral area of the rim on a twin wheel. The new feature according to the invention is that the twin wheel set includes a clamping ring with an external circumference, where the external circumference is adjustable by one or more adjusting screws, where said clamping ring preferably is a loose clamping ring.

The clamping ring may hereby be more or less loose relative to the rim of the twin wheel. The tightness by which the clamping ring fits against the rim of the twin wheel may be adjustable, as the clamping ring may be with an external circumference which is adjustable, preferably by one or more adjusting screws. By using a loose clamping ring, there is achieved the advantage that the clamping ring can be used for different rim widths, and in some cases for different rim diameters, e.g. 28″ and 30″ rims, and hence the stock at the producer can be minimised while at the same time many advantages are achieved by using modular elements.

By using the outer side of the rim for contact with the clamping ring, there is achieved independency of welding such means thereon to which clamping devices are to be fixed on the twin wheel itself By using a clamping ring which is not fixed to the twin wheel, a kind of universal clamping ring can be applied which possibly may be adapted to different sizes of twin wheels, and which therefore implies less need for keeping may different articles in stock at the producer or the sales outlet. By making the mentioned clamping ring in a neutral colour, e.g. in galvanised steel, there is achieved the advantage that a clamping ring, which does take up much space, can be used together with rims painted in a colour that fit the vehicle on which the twin wheel is to be mounted, without disturbing the overall impression.

A clamping ring according to the invention may be with a circular cross-section, preferably made of round steel, or with angular cross-section, preferably made of flat steel. It is thus possible to make a clamping ring that is suited for the specific rim design or as a kind of universal solution which is suited for innumerable different rim designs.

A particular preferred embodiment of a clamping ring is where the clamping ring is provided with rolled cross-section, where part of the cross-section substantially fits part of the cross-section of the rim. The clamping ring may e.g. be with a first cylindric part with a first diameter and with yet a cylindric part with another diameter, where these cylindric parts are connected with an entirely or partially radial part of the clamping ring. In other words, the clamping ring can be designed such that it corresponds to part of the outermost internal geometries of a rim for a twin wheel. The clamping ring may furthermore be provided with one or more upright edges and/or beads for engaging clamping devices which are mounted and act between the clamping ring and the wheel of the vehicle.

In another variant of a twin wheel set according to the invention, twin wheel and intermediate ring are capable of being separated. Hereby is also achieved the possibility of avoiding welds between rim and intermediate ring. Hereby is achieved the great advantage that the intermediate ring can be replaced by a wider or narrower intermediate ring. It is thus possible to adapt the spacing between twin wheel and vehicle wheel with regard to specific needs. At the same time, this provides the possibility of reduced stock, as intermediate rings and rims may be paired freely. For example, it may be wanted that there is a small spacing between the wheels when working the soil, while there is a wish for a given spacing between the wheels by other work, e.g. where fields with crops in rows are treated and to which the wheel spacing is to be adapted. These intermediate rings may advantageously be made in widths of 50 mm steps, e.g. widths of 150, 200, 250, 300, 350, 400, 450 mm or more, depending on the actual rim design.

In another variant, the intermediate ring may have adjustable width. For example with one or more detachable intermediate ring parts that may be bolted together or just mounted in mutual continuation.

A twin wheel set with fixing means according to the invention further includes one or more clamping devices which are arranged in non-extendable connection between the vehicle wheel and the adjustable clamping ring. These clamping devices are thus mounted between the clamping device which is mounted at the outer rim edge of the twin wheel and an anchoring on the vehicle wheel, preferably on the rim plate of this wheel.

The mentioned clamping devices may advantageously be screw connections, preferably screw connections combined with a mechanical closing and locking mechanism. Adjusting these clamping devices may be effected by using tools, but may also be effected manually without tools according to known principles.

The invention is described in the following with reference to the drawing, wherein:

### BRIEF DESCRIPTION OF THE DRAWINGS

FIG. 1 shows a cross-section of a twin mounting;

FIG. 2 shows an adjustable clamping ring;

FIG. 3 shows a detail with a rolled clamping ring mounted in a rim; and

FIG. 4 shows a rim with a rolled clamping ring and with a clamping part.

### DETAILED DESCRIPTION OF EMBODIMENTS OF THE INVENTION

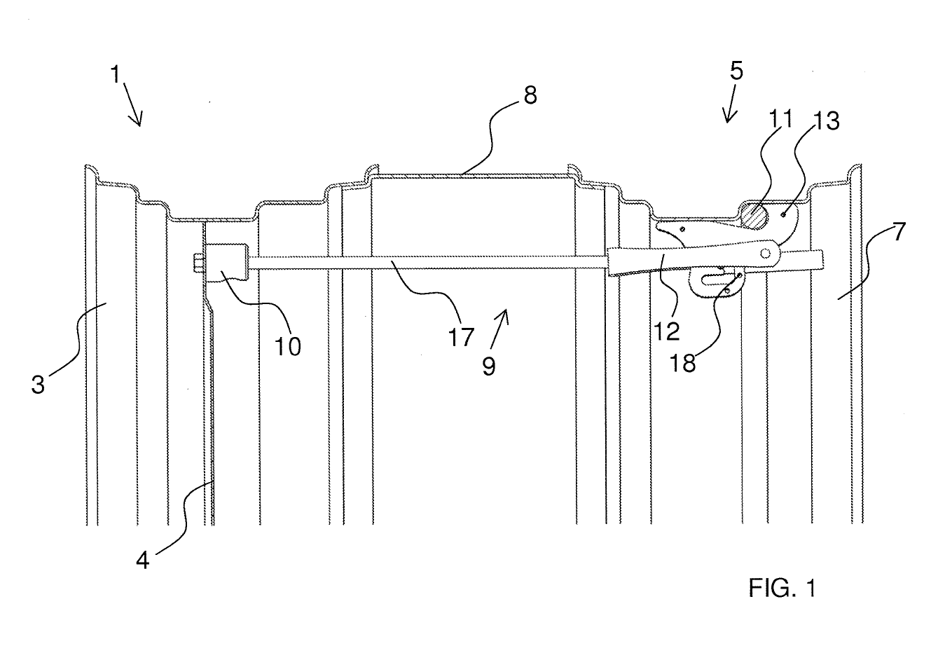

In FIG. 1 appears a cross-section of a twin mounting consisting of a vehicle wheel 1 without tyres, with rim 3 and with rim plate 4, and of a twin wheel 5, also with rim 7. Between the two rims 3 and 7 appears an intermediate ring 8.

The two rims 3 and 7 are held clamped together with several clamping devices 9, but here is only shown one of them. At one end, the clamping device 9 is fixed to an anchor 10 which is fastened to the rim plate 4 and at the other end to a clamping ring 11 which bears against the rim 7 of the twin wheel at the outward facing side of the latter. The clamping ring 11 is in principle a loose clamping ring 11 which is not permanently mounted by welding or similar to the rim 7. The clamping device 9 can be made in different ways, but in a preferred variant it is provided with adjustable length and with a closing device 12 with a kind of claw or clamp part 13 that ensures a secure connection to the clamping ring 11, and at the same time allows a rapid and certain tightening of the closing device 12.

The intermediate ring 8 is neither welded to the rim 3 of the vehicle nor to the rim 7 of the twin wheel. It is thus a loose intermediate ring 8 which may be adapted to the diameter of the rim 3, 7 with a desired tightness. A loose intermediate ring 8 can be glued in the rim 7, but may advantageously be loose and thereby easily replaceable. Thus it is possible to have several intermediate rings 8 with different widths, providing the possibility of adapting the entire twin mounting to a specific need. The great advantage of using a loose intermediate ring 8 and a loose clamping ring 11 is that no weldings have to be made on the rim 7 for a twin wheel 5. Respective intermediate rings 8 and clamping rings 11 are thus universal items that may be applied according to need with regard to a specific order, without having to weld the items together and subsequently paint them.

The previously mentioned clamping device 9 also includes a drawbar 17 that extends between the anchor part 10 on the vehicle rim 3 and the closing device 12. The drawbar 17 is adjustably connected to the closing device 12 that includes the clamp part 13 which acts directly on the clamping ring 11. The closing device 12 can be secured against loosening by accident by a safety pin which is mounted in a hole 18 in the closing device 12.

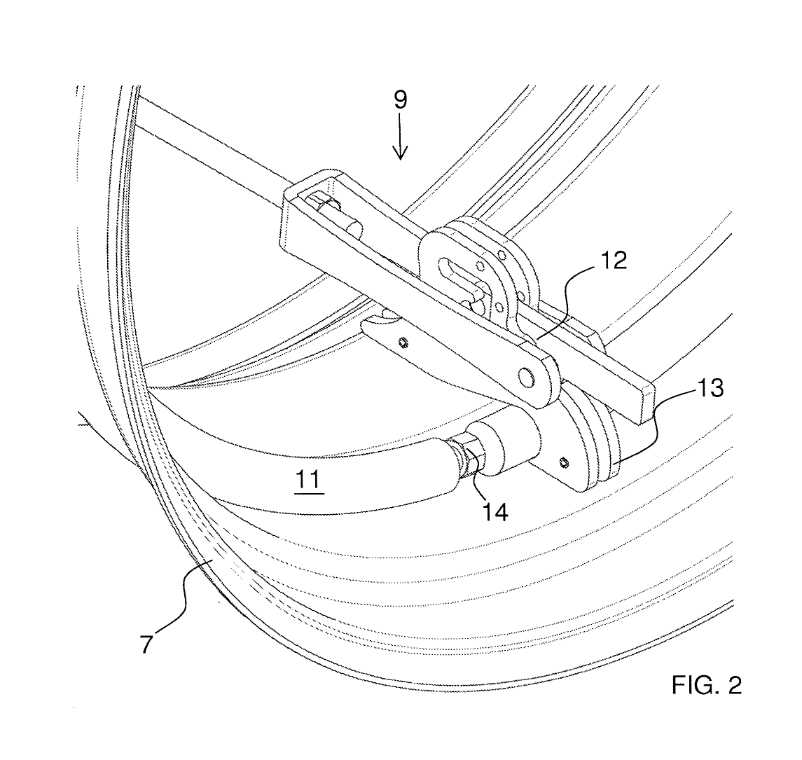

In FIG. 2 appears a variant of a clamping ring 11 made of round steel and which is rolled with a diameter corresponding to an internal diameter of a rim 7. The diameter of the shown clamping ring 11 can be slightly adjusted by performing an adjustment by the shown adjusting screw 14. In FIG. 2 is furthermore seen a clamp part 13 which is part of the clamping device 9. The clamp part 13 is only shown as an example and may be designed in many different ways.

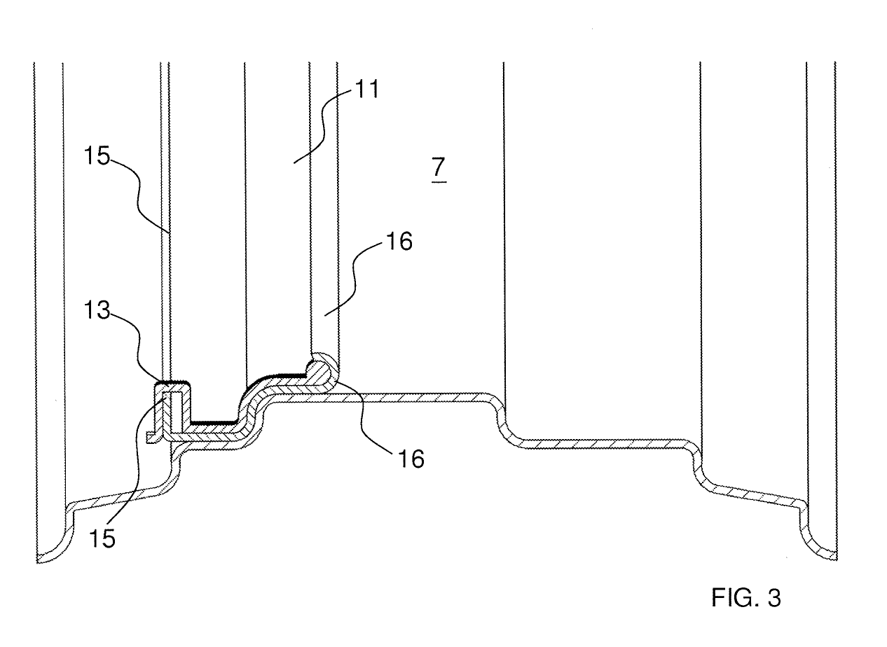

In FIG. 3 appears a detail of a rim 7 with a rolled clamping ring 11. The clamping ring 11 is rolled with a geometry substantially corresponding to the internal geometry of the rim and hence fitting perfectly into the rim 7. At the external side, a radial flange 15 is seen extending towards the centre of the rim and the clamping ring, and at the internal side of the clamping ring 11 appears a bead 16 that also extends towards the centre of the rim and the clamping ring. The flange 15 and the bead 16 have the purpose of ensuring sufficient rigidity in the clamping ring 11 and also to provide contact faces for the previously mentioned clamp part 13. The clamp part 13 may advantageously be designed with a shape following the internal geometry of the clamping ring.

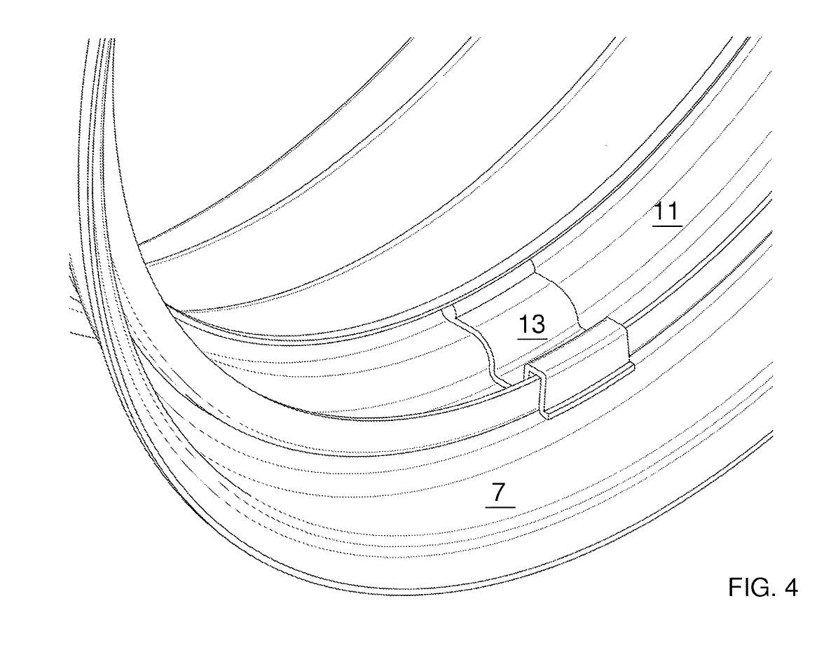

In FIG. 4 appears a rim 7 with a clamping ring 11 where the clamping ring is mounted at the external side of the rim geometry and by a shown clamp part 13. The clamp part 13 is intended for contact with a not shown clamping device 9 including a closing device 12.

1-9. (canceled)

10. A twin wheel set including twin wheel, intermediate ring and fixing means for coaxial mounting of the twin wheel set on a wheel of a vehicle, where the twin wheel as well as the vehicle wheel include a rim, preferably a steel rim with tyre, where the fixing means at least include a clamping ring, preferably a steel ring, for bearing against the rim periphery of the twin wheel at the side facing away from the vehicle wheel, preferably against at least one face of the inner peripheral area of the rim on a twin wheel, wherein the twin wheel set includes a clamping ring, with an external circumference, where the external circumference is adjustable by one or more adjusting screws, where said clamping ring preferably is a loose clamping ring.

11. Twin wheel set according to claim 10, wherein the clamping ring is provided with circular cross-section and preferably made of round steel.

12. Twin wheel set according to claim 10, wherein the clamping ring is provided with angular cross-section and preferably made of flat steel.

13. Twin wheel set according to claim 10, wherein the clamping ring is provided with rolled cross-section, where part of the cross-section substantially fits with part of the cross-section of the rim.

14. Twin wheel set according to claim 10, wherein twin wheel and intermediate ring can be separated.

15. Twin wheel set according to claim 14, wherein the intermediate ring is exchangeable with a wider or narrower intermediate ring.

16. Twin wheel set according to claim 14, wherein the intermediate ring is provided with adjustable width.

17. Twin wheel set according to claim 10, wherein the fixing means further include one or more clamping devices which are arranged in non-extendable connection between the vehicle wheel and the loose adjustable clamping ring.

18. Twin wheel set according to claim 17, wherein the clamping devices are screw connections, preferably screw connections combined with a mechanical closing and locking mechanism.

19. Twin wheel set according to claim 13, wherein twin wheel and intermediate ring can be separated.

20. Twin wheel set according to claim 16, wherein the fixing means further include one or more clamping devices which are arranged in non-extendable connection between the vehicle wheel and the loose adjustable clamping ring.
